(19) United States
(12) Patent Application Publication
(10) Pub. No.: US 2025/0172402 A1
(43) Pub. Date: May 29, 2025

(54) DELIVERY ROUTE SETTING DEVICE, DELIVERY ROUTE SETTING METHOD, AND NON-TRANSITORY COMPUTER READABLE MEMORY

(71) Applicant: Rakuten Group, Inc., Tokyo (JP)

(72) Inventors: Asaki MATSUMOTO, Tokyo (JP); Takayoshi INUMA, Tokyo (JP)

(73) Assignee: Rakuten Group, Inc., Tokyo (JP)

(21) Appl. No.: 18/947,643

(22) Filed: Nov. 14, 2024

(30) Foreign Application Priority Data
Nov. 27, 2023 (JP) 2023-199969

(51) Int. Cl. G01C 21/34; G05D 1/644; G05D 105/28

(52) U.S. Cl. CPC G01C 21/3461; G05D 1/644; G05D 2105/28

(57) ABSTRACT

A delivery control server 2 acquires the deliverable time zone of the target article to be delivered to the delivery destination by the UAV 1, acquires the satellite information relating to one or more positioning satellites that can be captured at each of a plurality of positions from the delivery base to the delivery destination of the target article in the deliverable time zone, and sets the delivery route from the delivery base to the delivery destination of the target article so as to avoid one or more positions where the positioning accuracy is relatively low in the deliverable time zone among the plurality of positions in the area from the delivery base to the delivery destination of the target article, on the basis of the acquired satellite information.

### CROSS REFERENCE TO RELATED APPLICATION

This application claims priority from Japanese Patent Application No. 2023-199969 which was filed on Nov. 27, 2023, the disclosure of which is herein incorporated by reference in its entirety.

### TECHNICAL FIELD

One or more embodiments of the present invention relate to a technical field of a system using an unmanned vehicle capable of receiving radio waves from positioning satellites and moving autonomously.

### RELATED ART

Conventionally, an autonomous movement using satellite positioning systems has become mainstream for an unmanned vehicle such as a drone. For example, in a technology disclosed in JP 2016-188806 A, a mobile object that detects its current position using positioning information from a satellite positioning system is able to accurately determine the current position even when satellite radio wave reception is poor when traveling through an area where map information is not registered.

However, since the positioning satellites used in the satellite positioning system move around the earth, the number of positioning satellites that can be captured by the drone may change depending on the time of day, especially in areas with a lot of obstructions, even if the drone is flying the same delivery route. Especially, in urban areas where a drone delivery is expected to be used in the future, it is assumed that buildings (e.g., high-rise buildings) are crowded together, the number of positioning satellite that can be captured may decrease depending on the flight time, thereby decreasing positioning accuracy. Moreover, the positioning accuracy may also decrease due to changes in a placement state (e.g., bias) of the positioning satellites depending on the flight time. There are concerns about an impact on safety of the unmanned vehicle and deliveries by the unmanned vehicle due to the decrease in the positioning accuracy as explained above.

Therefore, one or more embodiments of the present invention are to providing a delivery route setting device, delivery route setting method, and non-transitory computer readable memory, which are capable of efficiently setting a delivery route so as to avoid positions with low positioning accuracy during the time when an article can be delivered.

### SUMMARY

(An aspect 1) In response to the above issue: a delivery route setting device includes: at least one memory configured to store program code; and at least one processor configured to access the program code and operate as instructed by the program code. The program code includes: first acquisition code configured to cause the at least one processor to acquire a deliverable time zone for an article to be delivered to a delivery destination by an unmanned vehicle capable of receiving radio waves from one or more positioning satellites and moving autonomously; second acquisition code configured to cause the at least one processor to acquire satellite information relating to the one or more positioning satellites that can be captured at each of a plurality of positions between a delivery base of the article and the delivery destination in the deliverable time zone; and setting code configured to cause the at least one processor to set, on the basis of the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.
(An aspect 2) A display control method executed by one or more computers, includes: acquiring a deliverable time zone for an article to be delivered to a delivery destination by an unmanned vehicle capable of receiving radio waves from one or more positioning satellites and moving autonomously; acquiring satellite information relating to the one or more positioning satellites that can be captured at each of a plurality of positions between a delivery base of the article and the delivery destination in the deliverable time zone; and setting, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.
(An aspect 3) A non-transitory computer readable memory has stored thereon a program configured to cause a computer to: acquire a deliverable time zone for an article to be delivered to a delivery destination by an unmanned vehicle capable of receiving radio waves from one or more positioning satellites and moving autonomously; acquire satellite information relating to the one or more positioning satellites that can be captured at each of a plurality of positions between a delivery base of the article and the delivery destination in the deliverable time zone; and set, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.

### BRIEF DESCRIPTION OF THE DRAWINGS

FIG. 1 is a diagram illustrating a schematic configuration example of a delivery system S.

FIG. 2 is a diagram illustrating a schematic configuration example of an UAV 1.

FIG. 3 is a diagram illustrating a schematic configuration example of a delivery control server 2.

FIG. 4 is a diagram illustrating an example of functional blocks in a control unit 23.

FIG. 5 is a conceptual diagram illustrating an image from the side of candidate routes from a delivery base to a delivery destination.

FIG. 6 is conceptual diagram illustrating an image from the top of candidate routes from a delivery base to a delivery destination.

FIG. 7 is a diagram showing an example of a capture number and a DOP on each candidate route for each deliverable time zone.

FIG. 8 is a flowchart illustrating an example of a delivery route setting processing executed by the control unit 23 of the delivery control server 2 in Example 1.

FIG. 9 is a diagram illustrating a deliverable time zone selection screen in Example 1, displayed on a user terminal UT.

FIG. 10 is a diagram illustrating an example of a delivery route setting processing executed by the control unit 23 of the delivery control server 2 in Example 2.

FIG. 11 is a diagram illustrating a deliverable time zone selection screen in Example 2, displayed on the user terminal UT.

### DETAILED DESCRIPTION

Hereinafter, one or more embodiments of the present invention will be described with reference to the drawings. The following embodiment is an embodiment in a case where the present invention is applied to a delivery system for delivering one or more articles by an unmanned vehicle capable of receiving radio waves from one or more positioning satellites and moving autonomously. Incidentally, in this embodiment, an unmanned aerial vehicle (hereinafter, referred to as an “UAV (Unmanned Aerial Vehicle)”) is taken as an example of the unmanned vehicle. The UAV may be an unmanned flying robot.

### [1. Configuration and Operation Outline of Delivery System S]

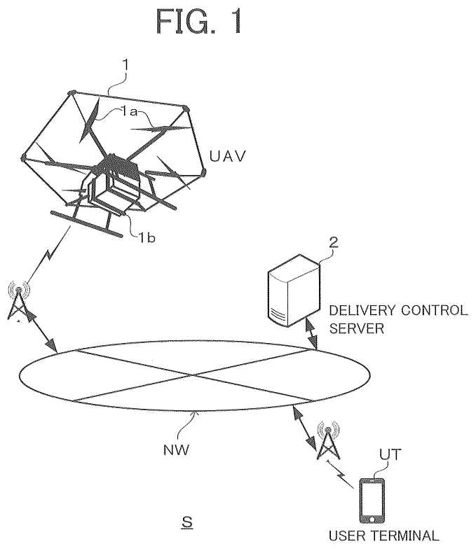

First, a configuration and operation outline of a delivery system S according to the present embodiment will be described with reference to FIG. 1. FIG. 1 is a diagram illustrating a schematic configuration example of the delivery system S. As illustrated in FIG. 1, the delivery system S includes an UAV, a delivery control server 2 (an example of the delivery route setting device, and the like. The UAV 1 is also called a drone or a multicopter. Incidentally, in the example of FIG. 1, one UAV 1 is shown, but in reality there are multiple UAVs 1. The delivery control server 2 is a server that controls and manages the delivery of one or more articles to be delivered as one or more packages (cargo). The UAV 1 and the delivery control server 2 are respectively connected to a communication network NW. The communication network NW includes, for example, the Internet, a mobile communication network and a radio base station thereof, and the like. The delivery control server 2 can be accessed by a user terminal UT via the communication network NW. The user terminal UT is a terminal (for example, a personal computer or a smartphone) used by a user who is a delivery requester.

The UAV 1 can autonomously fly (an example of autonomous movement) in the air from a delivery base of one or more articles to a delivery destination. The delivery base is a delivery source or transit point of the articles, and has, for example, a facility (e.g., a store that sells items) that handles the articles. A facility (e.g., a warehouse) for storing the articles may be installed at the delivery base. The delivery destination is a place selected (specified) by the user. The delivery destination is near an entrance of a building (for example, a main entrance of a detached house or a first floor entrance of a multiple dwelling house such as an apartment), a rooftop of a building, or the like, but is not particularly limited thereto. The article to be delivered may be an item (e.g., a product) ordered by a user, for example, on an EC (Electronic Commerce) site. Incidentally, the article to be delivered may be a home delivery item.

The user may select one or more articles to be delivered, the delivery base, and the delivery destination on a screen (e.g., a web page) displayed on the user terminal UT by accessing the EC site or the like from the user terminal UT. Moreover, the user terminal UT can display, in a selectable manner, a deliverable time zone (candidate) provided by the delivery control server 2. As a result, the deliverable time zone is presented to the user in a selectable manner. The deliverable time zone becomes, for the user, a desired delivery time zone. The deliverable time zone is a time zone including an a scheduled (estimated) arrival time of the UAV 1 carrying one or more articles at the delivery destination. Alternatively, the deliverable time zone is a time zone including a scheduled (estimated) time when the UAV 1 arrives at the delivery destination and can transfer (hand over) one or more articles. The deliverable time zone may include a scheduled departure time for the UAV 1 to depart from the delivery base. Incidentally, the time may be expressed by year, month, date and hour (hereinafter the same).

### [1-1. Configuration and Function of UAV 1]

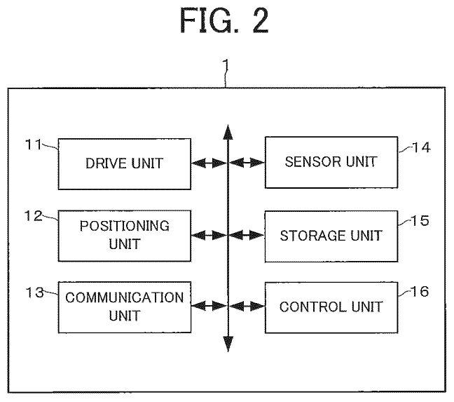

Next, a configuration and a function of the UAV 1 will be described with reference to FIG. 2. FIG. 2 is a diagram illustrating a schematic configuration example of the UAV 1. As illustrated in FIG. 2, the UAV 1 includes a drive unit 11, a positioning unit 12, a communication unit 13, a sensor unit 14, a storage unit 15, a control unit 16, and the like. Moreover, although not shown, the UAV 1 includes a battery that supplies power to each unit of the UAV 1. Moreover, as illustrated in FIG. 1, the UAV 1 includes rotors (propeller) 1a that are a plurality of horizontal rotary blades (wings) and a holding member 1b that holds one or more articles to be loaded. Incidentally, the UAV 1 may include a holding member or the like that holds the article to be loaded. The holding member 1b may hold a storage box for storing one or more articles. The drive unit 11 includes a motor, a rotation shaft, and the like. The drive unit 11 rotates a plurality of rotors 1a by the motor, the rotation shaft, and the like that are driven in accordance with a control signal output from the control unit 16.

The positioning unit 12 includes a radio wave receiver and the like. The positioning unit 12 receives radio waves transmitted from positioning satellites of a GNSS (Global Navigation Satellite System) by the radio wave receiver, and detects a current position of the UAV 1 on the basis of the radio waves. The current position of the UAV 1 may be expressed by the latitude and longitude (i.e., two-dimensional coordinates) of the UAV 1, or by the latitude, longitude, and altitude (i.e., three-dimensional coordinates) of the UAV 1. Incidentally, the positioning satellites may include satellites used by a plurality of satellite positioning systems, such as GPS (Global Positioning System) satellites, Michibiki (QZSS: Quasi-Zenith Satellite System) satellites, and Galileo satellites. Position information indicating the current position detected by the positioning unit 12 is output to the control unit 16. The communication unit 13 has a wireless communication function and controls communication performed via the communication network NW.

The sensor unit 14 includes various sensors used for flight control and the like for the UAV 1. The various sensors include, for example, an optical sensor, a triaxial angular velocity sensor, a triaxial acceleration sensor, a geomagnetic sensor, and the like. The optical sensor is configured to include a camera (for example, an RGB camera, an infrared camera), and continuously captures images of real space that falls within an angle of view of the camera. Incidentally, the optical sensor may include a LiDAR (Light Detection and Ranging, or Laser Imaging Detection and Ranging) sensor that measures a shape of a feature or a distance to a feature. Sensing information detected by the sensor unit 14 is output to the control unit 16.

The storage unit 15 includes a nonvolatile memory or the like, and stores various programs (program code group) and data. Moreover, the storage unit 15 stores a vehicle ID of the UAV 1. The vehicle ID of the UAV 1 is identification information for identifying the UAV 1. The control unit 16 includes at least one CPU (Central Processing Unit), a ROM (Read Only Memory), a RAM (Random Access Memory), and the like, and performs various controls according to the programs stored in the ROM or the storage unit 15. The various controls include flight control (including take-off control and landing control). In the flight control, the control unit 16 controls the rotation speed (the number of rotations) of the rotors 1a, along with the position, attitude, and traveling (movement) direction of the UAV 1 by using the position information acquired from the positioning unit 12, the sensing information acquired from the sensor unit 14, and the like.

Moreover, in the flight control, delivery control information is used. The delivery control information is provided from the delivery control server 2. The delivery control information includes, for example, a delivery route and a delivery schedule. The delivery route indicates a flight route from the delivery base to the delivery destination of one or more articles to be delivered. The delivery route (in other words, each position on the delivery route) may be expressed by latitude and longitude, or may be expressed by latitude, longitude, and altitude. The delivery schedule may include, for example, a scheduled departure time when the UAV 1 departs from the delivery base and a scheduled arrival time when the UAV 1 arrives at the delivery destination. The delivery schedule may include a scheduled passing time when the UAV 1 passes through each position on the delivery route.

### [1-2. Configuration and Function of Delivery Control Server 2]

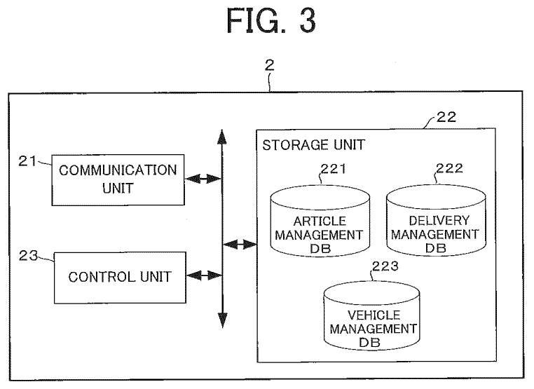

Next, a configuration and a function of the delivery control server 2 will be described with reference to FIG. 3. FIG. 3 is a diagram illustrating a schematic configuration example of the delivery control server 2. As illustrated in FIG. 3, the delivery control server 2 includes a communication unit 21, a storage unit 22, a control unit 23, and the like. The communication unit 21 controls communication performed via the communication network NW. Thereby, the delivery control server 2 can communicate with the UAV 1, and the user terminal UT. Furthermore, the delivery control server 2 can communicate via the communication network NW with a satellite orbit management server (not shown) that manages the respective orbits (trajectory) of the plurality of positioning satellites moving around the earth. Thereby, the delivery control server 2 receives orbit information indicating the respective orbits of the plurality of positioning satellites from the satellite orbit management server. The orbit information indicates the satellite position and time in the respective orbits of the positioning satellites. The satellite position and time are predicted, for example, 24 to 48 hours in advance. The satellite position is a position of the satellite at a future time, and is expressed, for example, by latitude, longitude, and altitude.

The storage unit 22 includes, for example, a hard disk drive (HDD), and stores various programs including an operating system (OS), an application, and the like. Here, the application (program) includes a program for executing a delivery route setting method. Moreover, the storage unit 22 stores map data of a delivery area including the delivery base and the delivery destination. The map data includes location information indicating positions of artifacts such as buildings installed within the delivery area, and structure information indicating structure of the artifacts. The position of the artifact may be expressed by latitude and longitude, or by latitude, longitude, and altitude. The structure of the artifact indicates, for example, the size (planar area) and height of the artifact. Incidentally, the map data may include position information indicating a position of a natural object (material) such as a tree, mountain, or hill that exists in the delivery area, and structure information indicating structure of the natural object.

Furthermore, in the storage unit 22, an article management database (DB) 221, a delivery management database (DB) 222, a vehicle management database (DB) 223, and the like are constructed. The article management database 221 is a database for managing information on one or more articles. In the article management database 221, for example, the article ID (for example, the item ID), article information of the article, delivery base information of the delivery base that handles the article, and inventory status of the article at the delivery base are stored (registered) in association with each article. Here, the article ID is identification information to identify the article (e.g., item). The article information includes the name, specifications, and price of the article to be delivered. The delivery base information indicates, for example, the address of the delivery base (e.g., facility), or latitude and longitude of the delivery base.

The delivery management database 222 is a database for managing information on the delivery of one or more articles. In the delivery management database 222, for example, a delivery ID (e.g., order ID), the article ID of the article selected by the user, the delivery base information of the delivery base handling the article, the delivery destination information of the delivery destination selected by the user, the delivery route, the delivery schedule and the like are stored in association with each delivery. Here, the delivery ID is identification information to identify the delivery (e.g., order). The delivery destination information indicates, for example, the address of delivery destination, or latitude and longitude of the delivery destination.

The vehicle management database 223 is a database for managing information on the UAV 1. In the vehicle management database 223, for example, the vehicle ID, the delivery base information of the delivery base where UAV 1 is deployed, an operating status (in other words, a working situation) of the UAV 1, and an available time zone of the UAV 1 and the like are stored in association with each UAV 1. Here, the operating status of the UAV 1 indicates whether it is operating or waiting (standing by). The operating indicates, for example, moving to prepare for delivery, being used for delivery, or, returning. The operating status is updated as appropriate. The available time zone of UAV 1 indicates the date and time zone which UAV 1 can be used for delivery.

The control unit 23 includes at least one CPU (an example of processor), a ROM, a RAM, and the like, and performs various processes according to the programs (program code) stored in the storage unit 22 or the ROM, or non-transitory computer readable memory. The CPU is configured to access the program code stored in the storage unit 22 or the memory and operate as instructed by the program code. The program code includes: first acquisition code configured to cause the CPU to acquire the deliverable time zone for the article to be delivered to the delivery destination by the UAV 1 capable of receiving radio waves from one or more positioning satellites and moving autonomously; second acquisition code configured to cause the CPU to acquire satellite information relating to the one or more positioning satellites that can be captured at each of a plurality of positions between the delivery base of the article and the delivery destination in the deliverable time zone; and setting code configured to cause the CPU to set, on the basis of the satellite information, a delivery route so as to avoid a position where positioning accuracy is less than or equal to a first threshold value in the deliverable time zone among the plurality of positions, the delivery route being a route for the UAV 1 to move autonomously from the delivery base to the delivery destination. Moreover, the program code may include: identification code configured to cause the CPU to identify one or more candidate routes to be candidates for the delivery route; and presentation control code configured to cause the CPU to present a plurality of different deliverable time zones in a selectable manner, to a delivery requester of the article, and to control the presentation of the deliverable time zones such that the delivery requester cannot select the deliverable time zone for which it is determined that there is not the candidate route whose a positioning accuracy satisfies a predetermined condition. In this case, the setting code may be configured to cause the CPU to set the delivery route for the deliverable time zone selected by the delivery requester among the presented deliverable time zones. Moreover, the program code may include movement control code configured to cause the CPU to perform a movement control of the UAV 1 such that the unmanned vehicle autonomously moves the delivery route that avoids the position where positioning accuracy is less than or equal to the first threshold value in the deliverable time zone.

Incidentally, the processor may be implemented using circuitry or processing circuitry which includes general purpose processors, special purpose processors, integrated circuits, ASICs, conventional circuitry and/or combinations thereof which are configured or programmed to perform the disclosed functionality. The processor may be hardware (or a combination of hardware and software) that carry out or are programmed to perform the recited functionality.

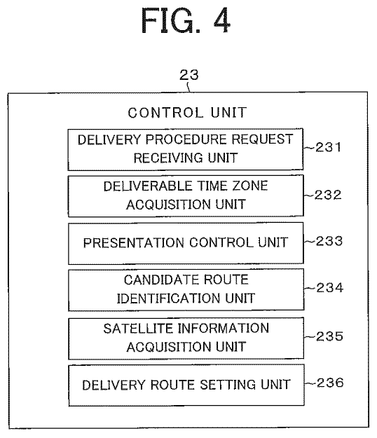

FIG. 4 is a diagram illustrating an example of functional blocks in the control unit 23. For example, in accordance with according to the programs (program code) stored in the storage unit 22 or the ROM, or non-transitory computer readable memory, the control unit 23 functions as a delivery procedure request receiving unit 231, a deliverable time zone acquisition unit 232, a presentation control unit 233, a candidate route identification unit 234, a satellite information acquisition unit 235, a delivery route setting unit 236, and the like, as illustrated in FIG. 4.

The delivery procedure request receiving unit 231 receives a delivery procedure request indicating one or more articles (hereinafter referred to as the “target article”) selected as a delivery target by the user, the delivery base, and the delivery destination on a screen displayed by an application (or browser) of the user terminal UT from the user terminal UT via the communication network NW and the communication unit 21. The delivery procedure request includes, for example, the article ID of the target article, the delivery base information, and the delivery destination information. Incidentally, the control unit 23 may search for, from the article management database 221, the delivery base that handles one or more articles selected by the user. In this case, the delivery base does not need to be selected by the user.

The deliverable time zone acquisition unit 232 acquires the deliverable time zone for the target article to be delivered to the delivery destination by the UAV 1. For example, the deliverable time zone acquisition unit 232 acquires a plurality of pre-classified different deliverable time zones as time zone candidates that can be selected by the user. Incidentally, the width (length) of the deliverable time zone can be set arbitrarily, and may be set to, for example, about two hours. Alternatively, it may be set to a time shorter or longer than two hours.

The presentation control unit 233 presents, to the user in a selectable manner, the one or more deliverable time zones acquired by the deliverable time zone acquisition unit 232. For example, the presentation control unit 233 transmits presentation information indicating the acquired one or more deliverable time zones to the user terminal UT, thereby causing the user terminal UT to display any one deliverable time zone in a selectable manner. Then, the presentation control unit 233 receives selection information indicating the deliverable time zone selected by the user from the user terminal UT via the communication network NW and the communication unit 21. Incidentally, the deliverable time zone acquired by the deliverable time zone acquisition unit 232 may be used for setting the delivery route without being presented to the user.

The candidate route identification unit 234 identifies a plurality of candidate routes that are candidates of the delivery route from the delivery base of the target article to the delivery destination. For example, the candidate route identification unit 234 preferably identifies the plurality of candidate routes from the delivery base to the delivery destination while avoiding the artifacts (man-made objects) and the like on a map represented by the map data stored in the storage unit 22. Incidentally, the candidate routes (in other words, each position on the candidate routes) may be expressed by latitude and longitude, or by latitude, longitude, and altitude.

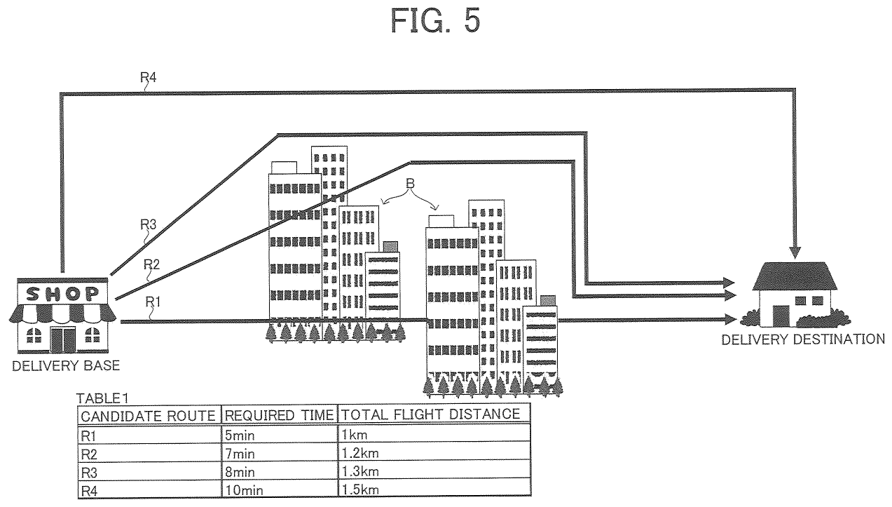

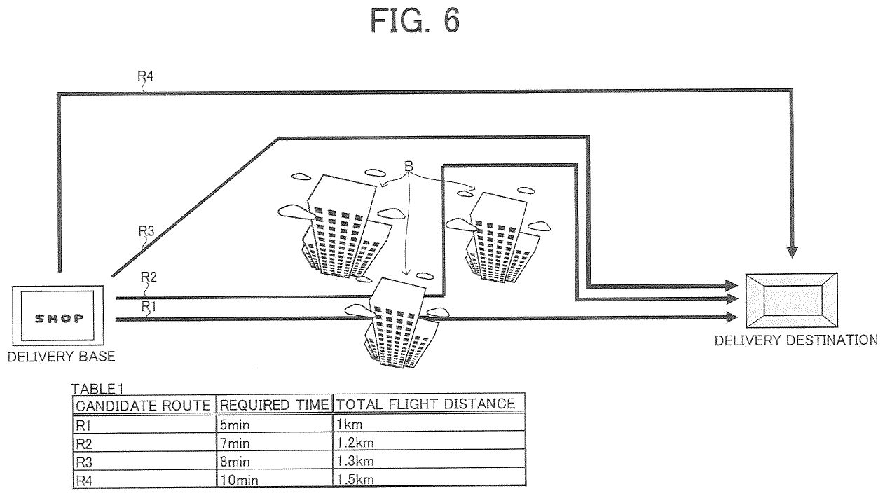

FIGS. 5 and 6 are conceptual diagrams illustrating an image of the candidate routes from the delivery base to the delivery destination. FIG. 5 depicts each of the candidate routes R1 to R4 from the side, and FIG. 6 depicts each of the candidate routes R1 to R4 from the top. Table 1 in FIG. 5 and FIG. 6 shows the required time (required travel time) and the total flight distance (required travel distance) of each of the candidate routes R1 to R4. Here, since the candidate route R1 is the shortest route that passes between buildings B, the required time and the total flight distance are the shortest. On the other hand, since the candidate route R4 is a route that bypasses buildings B, the required time and the total flight distance are the longest. On the other hand, since the candidate routes R2 and R3 are not the shortest routes, but they bypass part of buildings B, their required times and their total flight distances are longer than the candidate route R1 and shorter than the candidate route R4.

The satellite information acquisition unit 235 acquires satellite information relating to one or more positioning satellites that can be captured at each of a plurality of positions between the delivery base and the delivery destination of the target article in the deliverable time zone acquired by the deliverable time zone acquisition unit 232. In a case where a plurality of the deliverable time zones are acquired by the deliverable time zone acquisition unit 232, the satellite information acquisition unit 235 acquires the satellite information relating to the one or more positioning satellites that can be captured at each of the plurality of positions between the delivery base and the delivery destination of the target article in each deliverable time zone. The satellite information in each deliverable time zone may be different from each other or the same.

Here, the said “in the delivery time zone” may be any one arbitrary time (e.g., 10:00) during the deliverable time zone (e.g., 9:00-10:59), or plural arbitrary times (e.g., 9:00, 9:30, 10:00, 10:30, 10:59). In a case where the candidate route is identified by the candidate route identification unit 234, the said “plurality of positions” may be a plurality of positions on the candidate route (e.g., on a line with a predetermined width representing the candidate route). However, in a case where the candidate route is not identified, the said “plurality of positions” may be a plurality of positions set (e.g., randomly set) in an area from the delivery base to the delivery destination. Moreover, each position may be expressed by latitude and longitude (two-dimensional coordinates), or may be expressed by latitude, longitude, and altitude (three-dimensional coordinates).

The satellite information relating to the one or more positioning satellites includes, as an example, the number of the positioning satellites that can be captured in the coordinates (hereinafter simply referred to as the “capture number”). The higher the capture number, the higher the positioning accuracy. The capture number can be calculated by a capture number calculation algorithm. The capture number calculation algorithm calculates (outputs) the capture number by inputting the coordinates, orbit information acquired from the satellite orbit management server (e.g., the satellite positions at any time in the deliverable time zone), and data on the artifacts and/or natural objects present in the area surrounding the coordinates (e.g., location information of the artifacts and structural information of the artifacts, etc.). Especially, in a situation where buildings (e.g., high-rise buildings) are crowded together in urban areas, the accuracy of the capture number calculation can be improved by using data on buildings in the surrounding area of the coordinates. The program defining the capture number calculation algorithm may be installed in the control unit 23 and executed. Moreover, a publicly known program may be applied as such the program. Incidentally, such the program may be configured by a learned model (machine learning model) that outputs the capture number by taking the coordinates, the orbit information on the positioning satellites, and the data on the artifacts as inputs.

As described above, the capture number (i.e., the capture number at each coordinate) at arbitrary time during the deliverable time zone can be acquired as satellite information. Here, in a case where the capture number is calculated at each of a plurality of arbitrary times during the deliverable time zone, for example, the minimum value (or the average value) of these capture numbers may be acquired as satellite information. Moreover, a predetermined information collection device may collect the capture number of the positioning satellites actually captured by the positioning unit 12 during the flight (which may be a test flight) of the UAV 1. Furthermore, the predetermined information collection device may collect the capture position (two-dimensional coordinate or three-dimensional coordinate) and capture time of the positioning satellites actually captured by the positioning unit 12 during the flight of the UAV 1. In case where, set information of the capture number, the capture position, and the capture which are collected by the information collection device can be used by a program (e.g., a learned model) that defines the capture number calculation algorithm. This makes it possible to further improve the accuracy of calculating the capture number at the coordinates.

Moreover, the satellite information relating to the positioning satellites may include a reduction rate (rate of decline) of the positioning accuracy at the coordinates (hereinafter referred to as “DOP (Dilution Of Precision)”). The DOP depends on a placement state (e.g., bias) of the positioning satellites. The smaller the DOP, the higher the positioning accuracy. The DOP can be calculated by substituting the altitude angle and direction angle of the positioning satellites at the arbitrary time during the deliverable time zone into a predetermined matrix. The altitude angle and direction angle of the positioning satellites can be calculated from the coordinates and the orbit information acquired from the satellite orbit management server (i.e., the satellite position at the arbitrary time during the deliverable time zone). In a case where DOPs are calculated for each of a plurality of arbitrary times during the deliverable time zone, for example, the maximum value (or the average value) of these DOPs may be acquired as the satellite information. Moreover, in this case, the data on the artifacts and/or natural objects present (existing) in the surrounding area of the coordinate may also be used. Incidentally, the DOPs include HDOP indicating a reduction rate in horizontal positioning accuracy, and VDOP indicating a reduction rate in vertical positioning accuracy, but both the HDOP and/or the VDOP are used. In a case where both the HDOP and the VDOP are used, for example, the maximum value of the HDOP and the VDOP (or the average value of the HDOP and the VDOP) may be used as the DOP.

The delivery route setting unit 236 sets, on the basis of the acquired satellite information, a delivery route from the delivery base to the delivery destination so as to avoid one or more positions where the positioning accuracy is relatively low in the acquired deliverable time zone (e.g., the deliverable time zone selected by the user) among the plurality of positions from the delivery base to the delivery destination of the target article. The delivery route is a route for the UAV 1 to move autonomously from the delivery base to the delivery destination. Here, the said “so as to avoid” does not necessarily have to be set to be sure to avoid, as long as it is set to be avoided as much as possible. The said “the positioning accuracy is relatively low” means that the positioning accuracy is less than or equal to a first threshold value. Thus, the delivery route setting unit 236 preferably identifies one or more positions where the positioning accuracy is less than or equal to the first threshold value in the acquired deliverable time zone, and sets the delivery route that avoids the identified one or more positions. Accordingly, the control unit 23 can perform a movement control of the UAV 1 such that the UAV 1 autonomously moves the delivery route that avoids the one or more positions where positioning accuracy is less than or equal to the first threshold value in the deliverable time zone. For example, the delivery route setting unit 236 may set, on the basis of the acquired satellite information, the delivery route that passes through one or more positions where the positioning accuracy is relatively high (e.g., the highest) in the acquired deliverable time zone among the plurality of positions. This makes it possible to efficiently set the delivery route so as to accurately avoid the positions with low positioning accuracy in the deliverable time zone of the target article. The said “the positioning accuracy is relatively high” means that the positioning accuracy is greater than or equal to a second threshold value. The positioning accuracy is less than or equal to the first threshold value may be, for example, the capture number is less than a third threshold value (e.g., 5). In other words, the positioning accuracy is greater than or equal to the second threshold value may be, for example, the capture number is greater than or equal to the third threshold value. Alternatively, the positioning accuracy is less than or equal to the first threshold value may be, for example, the DOP is greater than a fourth threshold value (e.g., 3). In other words, the positioning accuracy is greater than or equal to the second threshold value may be, for example, the DOP is less than or equal to the fourth threshold value. Alternatively, the positioning accuracy is less than or equal to the first threshold value may be, for example, the capture number is less than the third threshold value and the DOP is greater than the fourth threshold value. Incidentally, the first threshold value, the second threshold value, the third threshold value, and the fourth threshold value are preset by a system administrator or the like.

For example, the delivery route setting unit 236 may set the delivery route that passes through one or more positions where the capture number is greater than or equal to the third threshold value. This makes it possible to efficiently set the delivery route so as to more accurately avoid the positions with low positioning accuracy in the deliverable time zone of the target article. Alternatively, the delivery route setting unit 236 may set the delivery route that passes through one or more positions where the DOP is less than or equal to the fourth threshold value. This also makes it possible to efficiently set the delivery route so as to more accurately avoid the positions with low positioning accuracy in the deliverable time zone of the target article. Alternatively, the delivery route setting unit 236 may set the delivery route that passes through one or more positions where the capture number is greater than or equal to the third threshold value and the DOP is less than or equal to the fourth threshold value. This also makes it possible to further efficiently set the delivery route so as to more accurately avoid the positions with low positioning accuracy in the deliverable time zone of the target article.

Moreover, the delivery route setting unit 236 may prioritize setting a delivery route that passes through one or more positions where the required time or the total flight distance from the delivery base to the delivery destination of the target article becomes relatively short, rather than passing through one or more positions where the positioning accuracy is relatively high in the deliverable time zone. That is, the delivery route setting unit 236 sets a first delivery route with priority over a second delivery route, wherein the first delivery route is the delivery route that passes through one or more positions where the positioning accuracy is greater than or equal to the second threshold value, and the second delivery route is a delivery route that passes through one or more positions where the required time or the total flight distance from the delivery base to the delivery destination is equal to or less than a fifth threshold value. This makes it possible to efficiently set the delivery route that enables the delivery of the target article to the delivery destination more quickly while avoiding positions with low positioning accuracy in the deliverable time zone of the target article. Incidentally, the fifth threshold value is preset by the system administrator or the like. Moreover, this makes it possible to efficiently set the delivery route that can reduce (save) power consumption of the battery of the UAV 1 while avoiding positions with low positioning accuracy in the deliverable time zone of the target article. For example, in case where a delivery route R10 that passes through one or more positions where the capture number is “4” take 5 minutes as the required time, and a delivery route R11 that passes through one or more positions where the capture number is “6” takes 15 minutes as the required time, while the delivery route R11 would be set from the standpoint of higher positioning accuracy, the delivery route R10 which has a relatively shorter required time, is determined as a priority (i.e., the delivery route R10 is given priority). Such processing may be performed, in particular, when the delivery route R11 becomes a detour, when the delivery route R11 becomes a detour and the target article does not reach within the deliverable time zone, or when there is no time margin. Here, whether or not the delivery route R11 becomes a detour may be determined by, for example, whether or not a distance difference or a time difference between the delivery route R11 and another delivery route is greater than or equal to a predetermined value (i.e., when the distance difference or the time difference is greater than or equal to the predetermined value, it is determined to be a detour). Moreover, the determination as to whether the delivery route R11 is a detour may take into account the remaining battery charge of the UAV 1. For example, even if the distance difference or the time difference is greater than or equal to the predetermined value, if the remaining battery charge of the UAV 1 is greater than or equal to a predetermined amount, it is determined that it is not a detour.

Moreover, in a case where the plurality of candidate routes are identified by the candidate route identification unit 234, the delivery route setting unit 236 may set, as the delivery route on the basis of the satellite information (i.e., satellite information of the candidate route) acquired at each of the plurality of positions on the identified candidate route, the candidate route whose the positioning accuracy satisfies a predetermined condition in the deliverable time zone among the plurality of candidate routes. This makes it possible to set more quickly the delivery route so as to avoid positions with low positioning accuracy in the deliverable time zone of the target article. Here, the candidate route whose positioning accuracy satisfies the predetermined condition is, for example, a candidate route that passes through a plurality of positions where the capture number is greater than or equal to the third threshold value. Alternatively, the candidate route whose positioning accuracy satisfies the predetermined condition may be, for example, a candidate route that passes through a plurality of positions where the DOP is less than or equal to the fourth threshold value. Incidentally, the candidate route whose positioning accuracy satisfies the predetermined condition may be a candidate route that do not pass through positions with relatively low positioning accuracy.

Moreover, in a case where there are a plurality of candidate routes whose the positioning accuracy satisfies the predetermined condition in the deliverable time zone, the delivery route setting unit 236 may set, as the delivery route, the candidate route that passes through a position with the highest positioning accuracy among the plurality of candidate routes. This makes it possible to set the delivery route so as to more accurately avoid the candidate route that passes through positions with low positioning accuracy in the deliverable time zone of the target article. Here, the position with the highest positioning accuracy among the plurality of candidate routes is, for example, a position with the highest capture number or a position with the lowest DOP.

Alternatively, the delivery route setting unit 236 set, as the delivery route, the candidate route that passes through more positions where the positioning accuracy is higher than the reference value among the plurality of candidate routes. This also makes it possible to set the delivery route so as to more accurately avoid the candidate route that passes through positions with low positioning accuracy in the deliverable time zone of the target article. Here, the position where the positioning accuracy is higher than the reference value is, for example, a position where the capture number is higher than a sixth threshold value (e.g., 6) that is greater than the third threshold value (e.g., 5). Alternatively, the position where the positioning accuracy is higher than the reference value may be a position where the DOP is lower than a seventh threshold value (e.g., 2) which is smaller than the fourth threshold value (e.g., 3). Incidentally, the sixth threshold value and the seventh threshold value are preset by the system administrator or the like. Moreover, the delivery route setting unit 236 may estimate, for each of the candidate routes, a delivery completion time to the delivery destination, and set the delivery route by excluding the candidate route whose the delivery completion time is not within the deliverable time zone (i.e., the target article does not arrive within the deliverable time zone) among the plurality of candidate routes. As a result, even if the candidate route has a relatively high positioning accuracy, if the candidate route is too detoured, the candidate route can be excluded from the delivery route.

Moreover, the delivery route setting unit 236 may determine, for each deliverable time zone, whether or not there is the candidate route whose the positioning accuracy satisfies the predetermined condition on the basis of the satellite information of the candidate route, before the deliverable time zones are presented to the user by the presentation control unit 233. In this case, the presentation control unit 233 performs control (hereinafter referred to as the “selection exclusion control”) so that the user cannot select the deliverable time zone at which it is determined that there is no candidate route whose the positioning accuracy satisfies the predetermined condition. This makes it possible to efficiently set, without waste, the delivery route that avoids positions with low positioning accuracy in the deliverable time zone of the target article. In this case, the delivery route setting unit 236 sets the delivery route in the deliverable time zone selected by the user from among the deliverable time zones other than the deliverable time zone to be excluded from selection (hereinafter referred to as the “selection exclusion target”). For example, the presentation control unit 233 performs the selection exclusion control so that the presentation information does not include the deliverable time zone to be excluded from selection. Alternatively, the presentation control unit 233 may perform the selection exclusion control so that the presentation information includes information indicating that the deliverable time zone of the selection exclusion target is not selectable (e.g., control data for graying out a selection button) along with the deliverable time zone of the selection exclusion target. Here, the presentation information may include control data for graying out a selection button, as the information indicating that the deliverable time zone of the selection exclusion target is not selectable.

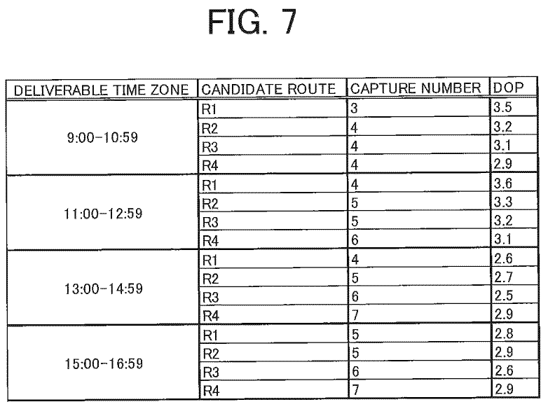

FIG. 7 is a diagram showing an example of the capture number and the DOP on each candidate route for each deliverable time zone. Here, the capture number on the candidate route is, for example, the minimum value (or the average value) of the capture number acquired at each of a plurality of positions on the candidate route. On the other hand, the DOP on the candidate route is, for example, the minimum value (or the average value) of the DOP acquired at each of a plurality of positions on the candidate route. In the example of FIG. 7, the capture number and the DOP on each of the candidate routes R1 to R4 are shown for each the deliverable time zone. In a case where it is determined whether there is a candidate route whose the positioning accuracy satisfies the predetermined condition based on the capture number on the candidate route, when the third threshold value is set to “5”, the deliverable time zone “9:00-10:59” is determined that there is no candidate route whose the positioning accuracy satisfies the predetermined condition, because each of the capture numbers on the candidate routes R1 to R4 is less than the third threshold. On the other hand, the deliverable time zone “11:00-12:59” is determined that there are candidate routes whose the positioning accuracy satisfies the predetermined condition, because each of the capture numbers of the candidate routes R2 to R4 is greater than or equal to the third threshold.

Moreover, in a case where it is determined whether there is a candidate route whose the positioning accuracy satisfies the predetermined condition based on the DOP on the candidate route, when the fourth threshold value is set to “3”, the deliverable time zone “9:00-10:59” is determined that there is a candidate route whose the positioning accuracy satisfies the predetermined condition, because the DOP on the candidate route R4 is less than or equal to the fourth threshold. On the other hand, the deliverable time zone “11:00-12:59” is determined that there is no candidate route whose the positioning accuracy satisfies the predetermined condition, because each of the capture numbers on the candidate routes R1 to R4 is greater than the fourth threshold. Incidentally, it may be determined whether or not there is a candidate route whose the positioning accuracy satisfies the predetermined condition based on a combination of the capture number and DOP on the candidate route. In this case, for example, a candidate route whose the capture number is greater than or equal to the third threshold and the DOP is less than or equal to the fourth threshold, is determined to be a candidate route whose the positioning accuracy satisfies the predetermined condition.

### [2. Operation of Delivery System S]

Next, an operation of the delivery system S according to this embodiment will be described in Example 1 and Example 2. Incidentally, in Example 1 and Example 2, a delivery procedure request is transmitted to the delivery control server 2. The delivery procedure indicates the target article, the delivery base, the delivery destination, and the like that are selected by the user on the screen displayed on the user terminal UT.

### Example 1

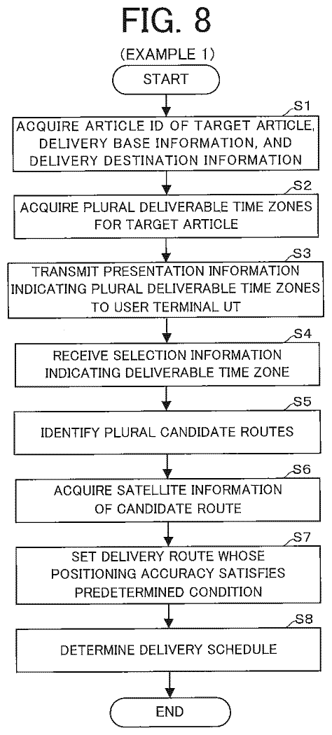

First, the operation of the delivery system S according to Example 1 will be described with reference to FIG. 8. FIG. 8 is a flowchart illustrating an example of a delivery route setting processing executed by the control unit 23 of the delivery control server 2 in Example 1. The processing illustrated in FIG. 8 is started, for example, when the delivery procedure request from the user terminal UT is received (accepted) by the delivery procedure request receiving unit 231. When the processing illustrated in FIG. 8 is started, the control unit 23 acquires the article ID of the target article, the delivery base information, and the delivery destination information from the delivery procedure request (step S1). The article ID, the delivery base information, and the delivery destination information acquired in this way are used in the following processes (i.e., steps).

Next, the control unit 23 (the deliverable time zone acquisition unit 232) acquires a plurality of the deliverable time zones (candidates) for the target article (step S2). At this time, the deliverable time zone acquisition unit 232 may determine the deliverable time zone in which the UAV 1 can be used based on the operating status (usage status) and the available time zone of the UAV 1 deployed at the delivery base. Next, the control unit 23 (the presentation control unit 233) transmits the presentation information indicating the plurality of the deliverable time zones acquired in step S2 to the user terminal UT via the communication unit 21 (step S3). As a result, the deliverable time zones are displayed on the user terminal UT so that the user can select any one of the deliverable time zones.

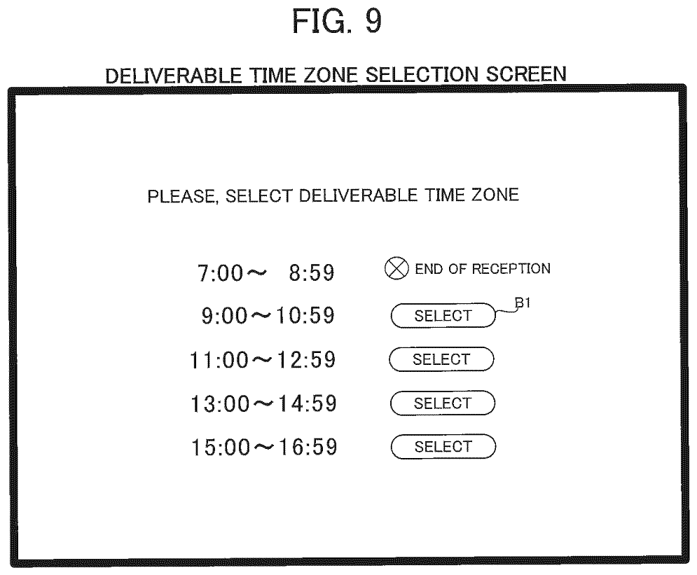

FIG. 9 is a diagram illustrating a deliverable time zone selection screen in Example 1, displayed on the user terminal UT. The deliverable time zone selection screen illustrated in FIG. 9 displays “7:00-8:59”, “9:00-10:59”, “11:00-12:59”, “13:00-14:59”, and “15:00-16:59” as the deliverable time zones. For example, when the “SELECT” button B1 associated with “9:00-10:59” is designated by the user, the button B1 changes to “SELECTED”. Then, selection information indicating the deliverable time zone selected by the user is transmitted from the user terminal UT to the delivery control server 2. The selection information may include an article ID. Incidentally, the deliverable time zone “7:00-8:59” shown in FIG. 9 cannot be selected due to the end of reception.

Next, when the selection information from the user terminal UT is received by the communication unit 21 (step S4), the control unit 23 (the candidate route identification unit 234) identifies a plurality of candidate routes to be candidates for the delivery route from the delivery base to the delivery destination of the target article as described above (step S5). At this time, the candidate route identification unit 234 may calculate (estimate) the required time or the total flight distance from the delivery base to the delivery destination of the target article. Next, the control unit 23 (the satellite information acquisition unit 235) acquires, for each candidate route, the satellite information of the candidate route identified in step S5, in the deliverable time zone indicated by the selection information received in step S4 (step S6). The satellite information includes at least one of the capture number and the DOP calculated as described above.

Next, the control unit 23 (the delivery route setting unit 236) sets, as the delivery route, a candidate route whose the positioning accuracy satisfies the predetermined condition so as to avoid one or more positions where the positioning accuracy is relatively low among the plurality of candidate routes, based on the satellite information acquired in step S6 (i.e., satellite information for each candidate route) (step S7). For example, the delivery route setting unit 236 sets, as the delivery route, a candidate route that passes through a plurality of positions where the capture number included in the satellite information becomes greater than or equal to the third threshold (e.g., 5). Alternatively, the delivery route setting unit 236 may set, as the delivery route, a candidate route that passes through a plurality of positions where the DOP included in the satellite information becomes less than or equal to the fourth threshold (e.g., 3). Alternatively, the delivery route setting unit 236 may set, as the delivery route, a candidate route that passes through the most positions where the capture number included in the satellite information becomes higher than the sixth threshold value (e.g., 6) that is greater than the third threshold value (e.g., 5). Alternatively, the delivery route setting unit 236 may set, as the delivery route, a candidate route that passes through the most positions where the DOP included in the satellite information becomes lower than the seventh threshold value (e.g., 2) which is smaller than the fourth threshold value (e.g., 3).

Moreover, when a plurality of candidate routes whose the positioning accuracy satisfies the predetermined condition are identified, the delivery route setting unit 236 preferably compares the required time or the total flight distance of these candidate routes. In this case, the delivery route setting unit 236 sets, the delivery route, a candidate route that has the shortest required time or the shortest total flight distance among the compared candidate routes. This makes it possible to preferentially set the candidate route in which the required time or the total flight distance is relatively shorter, rather than passing through one or more positions with relatively high positioning accuracy. Incidentally, such processing to prioritize the candidate route with relatively shorter required time or shorter total flight distance may be performed only when the difference in the capture number or the DOP between the compared candidate routes is small (e.g., less than a threshold value (e.g., 1)).

As another example, when a plurality of candidate routes whose the positioning accuracy satisfies the predetermined condition are identified, the delivery route setting unit 236 may estimate, for each candidate route, a delivery completion time (e.g., an estimated time at which the target article is provided to a recipient) of the target article to the delivery destination. In this case, the delivery route setting unit 236 sets the delivery route by excluding the candidate route whose the delivery completion time is not included within the deliverable time zone among the plurality of candidate routes. Alternatively, the delivery route setting unit 236 may set the delivery route by excluding, from among the plurality of candidate routes, the candidate route in which the time difference between the delivery completion time and the end point of the deliverable time zone is small and cannot be afforded in time (e.g., the time difference is 5 minutes or less).

Next, the control unit 23 (the delivery route setting unit 236) determines a delivery schedule including a scheduled departure time for the UAV 1, which has been determined as unmanned vehicle that will deliver the target article, and a scheduled arrival time for the UAV 1 (step S8), and terminates the processing shown in FIG. 8. Once the delivery schedule is determined in this manner, a delivery ID is assigned to the article ID of the target article, the delivery base information, the delivery destination information, the delivery route, the delivery schedule and the like, and these are registered (stored) in the delivery management database 222. Then, delivery control information including the set delivery route, the delivery schedule and the like is transmitted from the delivery control server 2 to the UAV 1. As a result, when the scheduled departure time of the UAV 1 arrives, the UAV 1 carrying the target article departs (starts flight) from the delivery base.

### Example 2

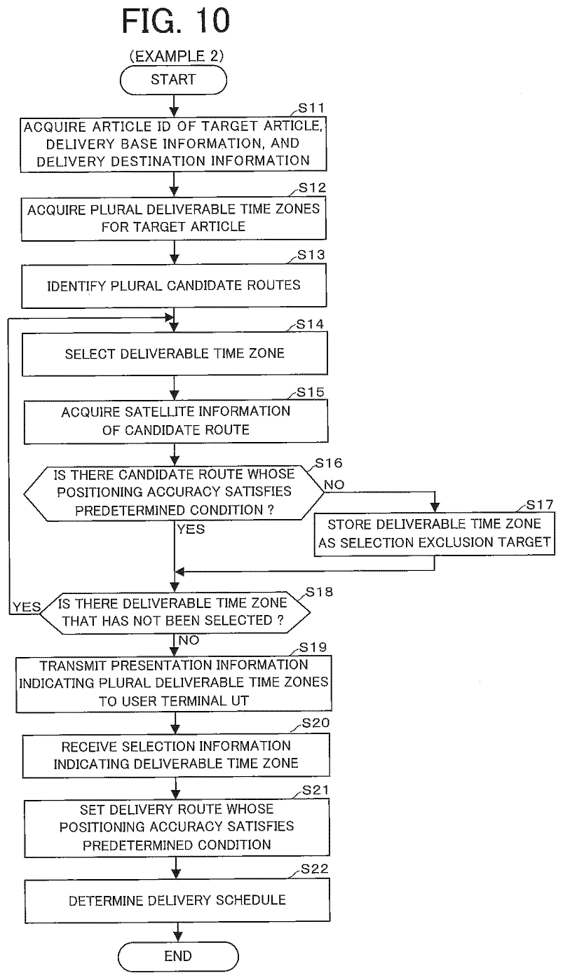

Next, the operation of the delivery system S according to Example 2 will be described with reference to FIG. 10. FIG. 10 is a flowchart illustrating an example of a delivery route setting processing executed by the control unit 23 of the delivery control server 2 in Example 2. The processing illustrated in FIG. 10 is started, for example, when the delivery procedure request from the user terminal UT is received by the delivery procedure request receiving unit 231. When the processing illustrated in FIG. 10 is started, the control unit 23 acquires the article ID of the target article, the delivery base information, and the delivery destination information from the delivery procedure request (step S11), similar to step S1.

Next, the control unit 23 (the deliverable time zone acquisition unit 232) acquires a plurality of the deliverable time zones (candidates) for the target article (step S12), similar to step S2. Next, the control unit 23 (the candidate route identification unit 234) identifies a plurality of candidate routes to be candidates for the delivery route from the delivery base to the delivery destination of the target article (step S13), similar to step S5. Next, the control unit 23 selects one deliverable time zone from among the plurality of deliverable time zones acquired in step S12 (step S14).

Next, the control unit 23 (the satellite information acquisition unit 235) acquires, for each candidate route, the satellite information of the candidate route identified in step S13, in the deliverable time zone selected in step S14 (step S15). Next, the control unit 23 (the delivery route setting unit 236) determines whether or not one or more candidate routes whose the positioning accuracy satisfies the predetermined condition are included in the plurality of candidate routes, based on the satellite information of the respective candidate routes acquired in step S15 (step S16). That is, it is determined that whether there are one or more candidate routes whose the positioning accuracy satisfies the predetermined condition in the plurality of candidate routes.

For example, it is determined whether or not one or more candidate routes whose the capture number is greater than or equal to the third threshold value, are included in the plurality of candidate routes. Alternatively, it is determined whether or not one or more candidate routes whose the DOP is less than or equal to the fourth threshold value, are included in the plurality of candidate routes. Alternatively, it is determined whether or not one or more candidate routes whose the capture number is greater than or equal to the third threshold value and the DOP is less than or equal to the fourth threshold value, are included in the plurality of candidate routes. Then, when it is determined that one or more candidate routes whose the positioning accuracy satisfies the predetermined condition are included in the plurality of candidate routes (step S16: YES), the processing proceeds to step S18. On the other hand, when it is determined that candidate routes whose the positioning accuracy satisfies the predetermined condition are not included in the plurality of candidate routes (step S16: NO), the deliverable time zone selected in step S14 is stored as the selection exclusion target (step S17), and the processing proceeds to step S18.

In step S18, the control unit 23 determines whether or not there is a deliverable time zone that has not yet been selected among the plurality of the deliverable time zones acquired in step S12. When it is determined that there is a deliverable time zone that has not yet been selected (step S18: YES), the processing returns to step S14, one deliverable time zone that has not yet been selected is selected from among the plurality of the deliverable time zones, and the above processing is repeated. On the other hand, when it is determined that there is no deliverable time zone that has not yet been selected (step S18: NO), the processing proceeds to step S19.

In step S19, the control unit 23 (the presentation control unit 233) transmits presentation information indicating the plurality of the deliverable time zones acquired in step S12 to the user terminal UT via the communication unit 21. In the case where the deliverable time zone is stored as the selection exclusion target in step S17, the presented information indicates the deliverable time zone being the selection exclusion target. As a result, one or more delivery time zones other than the selection exclusion target are displayed on the user terminal UT in a selectable manner.

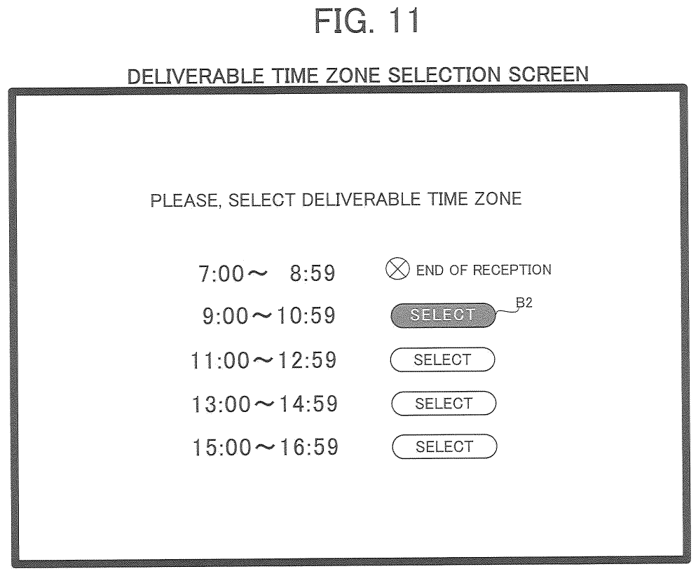

FIG. 11 is a diagram illustrating a deliverable time zone selection screen in Example 2, displayed on the user terminal UT. The deliverable time zone selection screen illustrated in FIG. 11 displays “7:00-8:59”, “9:00-10:59”, “11:00-12:59”, “13:00-14:59”, and “15:00-16:59” as the deliverable time zones. Of these, the deliverable time zone “9:00-10:59” is the deliverable time zone of the selection exclusion target, and the “SELECT” button B2 is grayed out so that the user cannot select it. Incidentally, the deliverable time zone of the selection exclusion target may be not displayed on the deliverable time zone selection screen in Example 2. Then, selection information indicating the deliverable time zone selected by the user is transmitted from the user terminal UT to the delivery control server 2. Incidentally, the deliverable time zone “7:00-8:59” shown in FIG. 11 cannot be selected due to the end of reception.

Once the selection information from the user terminal UT is received by the communication unit 21 (step S20), the control unit 23 (the delivery route setting unit 236) sets, as the delivery route, a candidate route whose the positioning accuracy satisfies the predetermined condition among the plurality of candidate routes so as to avoid one or more positions where the positioning accuracy is relatively low in the deliverable time zone selected by the user, in accordance with the processing result in step S16 (step S21). Next, the control unit 23 (the delivery route setting unit 236) determines a delivery schedule including a scheduled departure time for the UAV 1, which has been determined as unmanned vehicle that will deliver the target article, and a scheduled arrival time for the UAV 1 (step S22), and terminates the processing shown in FIG. 10. The subsequent processes are the same as in Example 1.

As described above, according to the embodiment, the delivery control server 2 acquires the deliverable time zone of the target article to be delivered to the delivery destination by the UAV 1, acquires the satellite information relating to one or more positioning satellites that can be captured at each of a plurality of positions from the delivery base to the delivery destination of the target article in the deliverable time zone, and sets the delivery route from the delivery base to the delivery destination of the target article so as to avoid one or more positions where the positioning accuracy is relatively low in the deliverable time zone among the plurality of positions in the area from the delivery base to the delivery destination of the target article, on the basis of the acquired satellite information. By configuring in this way, it is possible to efficiently set the delivery route so as to avoid positions with low positioning accuracy during the time when the target article can be delivered. Therefore, it is possible to prevent occurring of unexpected situations and delays in delivery of the target article, by the UAV 1 flying to an unexpected direction or stopping on the spot due to insufficient capture of the positioning satellites. Especially, in a situation where buildings (e.g., high-rise buildings) are crowded together in urban areas, it is assumed that the capture number of positioning satellites is relatively low (or the DOP is relatively high) depending on the flight time and flight position of the UAV 1. However, even in such a case, according to the above embodiment, it is possible to more effectively prevent occurring of unexpected situations and delays in delivery of the target article.

Incidentally, the above-described embodiment is one embodiment of the present invention, and the present invention is not limited to the above-described embodiment, changes from the above-described embodiment can be made on various configurations and the like within a scope not departing from the gist of the present invention, and such cases shall be also included in the technical scope of the present invention. In the above embodiment, in a case where one or more candidate routes are not identified, the delivery control server 2 may set the delivery route by sequentially tracing a plurality of positions where the capture number is greater than or equal to the third threshold value and/or a plurality of positions where the DOP is less than or equal to the fourth threshold value from the delivery base to the delivery destination. Incidentally, in the above embodiment, the capture number of positioning satellites and the DOP are used as examples of parameters related to the positioning accuracy, but the delivery route may be set to avoid positions with relatively low positioning accuracy in the deliverable time zone, based on other parameters related to the positioning accuracy. In the above embodiment, the UAV has been described as an example of the unmanned vehicle, but the present invention is also applicable to an UGV (Unmanned Ground Vehicle) that can travel autonomously on the ground.

### Note

[1] A delivery route setting device according to the present disclosure includes: a first acquisition unit configured to acquire a deliverable time zone for an article to be delivered to a delivery destination by an unmanned vehicle capable of receiving radio waves from one or more positioning satellites and moving autonomously; a second acquisition unit configured to acquire satellite information relating to the one or more positioning satellites that can be captured at each of a plurality of positions between a delivery base of the article and the delivery destination in the deliverable time zone; and a setting unit configured to set, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination. This makes it possible to efficiently set the delivery route so as to avoid positions with low positioning accuracy in the deliverable time zone of the article.
[2] In the delivery route setting device described in [1] above, the setting unit is configured to identify, based on the satellite information, the position where positioning accuracy is less than or equal to the first threshold value in the deliverable time zone; and to set the delivery route that avoids the identified position. This makes it possible to efficiently set the delivery route so as to avoid positions with low positioning accuracy in the deliverable time zone of the article.
[3] In the delivery route setting device described in [1] or [2] above, the setting unit is configured to set, based on the satellite information, the delivery route that passes through a position where the positioning accuracy is greater than or equal to a second threshold value in the deliverable time zone among the plurality of positions. This makes it possible to efficiently set the delivery route so as to more accurately avoid the positions with low positioning accuracy in the deliverable time zone of the article.
[4] In the delivery route setting device described in [3] above, the satellite information includes a capture number of the one or more positioning satellites, the capture number being identified at each of the plurality of positions, and the setting unit is configured to set the delivery route that passes through a position where the capture number is greater than or equal to a third threshold value. This makes it possible to efficiently set the delivery route so as to more accurately avoid the positions with low positioning accuracy in the deliverable time zone of the article.
[5] In the delivery route setting device described in [3] above, the satellite information includes a reduction rate of the positioning accuracy, the reduction rate being identified at each of the plurality of positions, and the setting unit is configured to set the delivery route that passes through a position where the reduction rate is less than or equal to a fourth threshold value. This makes it possible to efficiently set the delivery route so as to more accurately avoid the positions with low positioning accuracy in the deliverable time zone of the article.
[6] In the delivery route setting device described in [3] above, the satellite information includes a capture number of the one or more positioning satellites and a reduction rate of the positioning accuracy, the capture number and the reduction rate being identified at each of the plurality of positions, the setting unit is configured to set the delivery route that passes through a position where the capture number is greater than or equal to a third threshold value and the reduction rate is less than or equal to a fourth threshold value. This makes it possible to efficiently set the delivery route so as to more accurately avoid the positions with low positioning accuracy in the deliverable time zone of the article.
[7] In the delivery route setting device described in any one of [3] to [6] above, the setting unit is configured to set a first delivery route with priority over a second delivery route, the first delivery route being the delivery route that passes through the position where the positioning accuracy is greater than or equal to the second threshold value, and the second delivery route being a delivery route that passes through a position where a required travel time or a required travel distance from the delivery base to the delivery destination is equal to or less than a fifth threshold value. This makes it possible to efficiently set the delivery route that enables the delivery of the article to the delivery destination more quickly while avoiding positions with low positioning accuracy in the deliverable time zone of the article.
[8] The delivery route setting device described in any one of [1] to [7] above, further includes: an identification unit configured to identify one or more candidate routes to be candidates for the delivery route; and a presentation control unit configured to present a plurality of different deliverable time zones in a selectable manner, to a delivery requester of the article; wherein the second acquisition unit is configured to acquire the satellite information relating to the one or more positioning satellites that can be captured at each of a plurality of positions on the identified one or more candidate routes in each of the plurality of different deliverable time zones, the setting unit is configured to determine, for each of the deliverable time zones, whether or not there is the candidate route whose the positioning accuracy satisfies a predetermined condition, based on the satellite information acquired in each of the deliverable time zones, the presentation control unit is configured to control the presentation of the deliverable time zones such that the delivery requester cannot select the deliverable time zone for which it is determined that there is not the candidate route whose the positioning accuracy satisfies the predetermined condition, and the setting unit is configured to set the delivery route for the deliverable time zone selected by the delivery requester among the presented deliverable time zones. This makes it possible to set, without waste, the delivery route that avoids positions with low positioning accuracy in the deliverable time zone of the article.
[9] The delivery route setting device described in any one of [1] to [8] above, further includes an identification unit configured to identify a plurality of candidate routes to be candidates for the delivery route; wherein the second acquisition unit is configured to acquire, for each of the candidate routes, the satellite information relating to the one or more positioning satellites that can be captured at each of a plurality of positions on the identified one or more candidate routes in the deliverable time zone, and the setting unit is configured to set, as the delivery route based on the satellite information, the candidate route whose the positioning accuracy satisfies a predetermined condition in the deliverable time zone among the plurality of candidate routes. This makes it possible to efficiently set the delivery route so as to avoid positions with low positioning accuracy in the deliverable time zone of the article.
[10] In the delivery route setting device described in [9] above, in a case where there are a plurality of candidate routes whose the positioning accuracy satisfies the predetermined condition in the deliverable time zone, the setting unit is configured to set, as the delivery route, the candidate route that passes through a position with the highest positioning accuracy among the plurality of candidate routes. This makes it possible to set the delivery route so as to more accurately avoid the candidate route that passes through positions with low positioning accuracy in the deliverable time zone of the article.
[11] In the delivery route setting device described in [9] or above, in a case where there are a plurality of candidate routes whose the positioning accuracy satisfies the predetermined condition in the deliverable time zone, the setting unit is configured to set, as the delivery route, the candidate route that passes through more locations with the positioning accuracy higher than a reference value among the plurality of candidate routes. This makes it possible to set the delivery route so as to more accurately avoid the candidate route that passes through positions with low positioning accuracy in the deliverable time zone of the article.
[12] In the delivery route setting device described in any one of [9] to above, the setting unit is configured to estimate, for each of the candidate routes, a delivery completion time to the delivery destination, and set the delivery route by excluding the candidate route whose the delivery completion time is not within the deliverable time zone among the plurality of candidate routes. Thus, even if the candidate route has a relatively high positioning accuracy, if the candidate route is too detoured, the candidate route can be excluded from the delivery route.
[13] The delivery route setting device described in any one of [1] to above, further includes a movement control unit configured to perform a movement control of the unmanned vehicle such that the unmanned vehicle autonomously moves the delivery route that avoids the position where positioning accuracy is less than or equal to the first threshold value in the deliverable time zone.
[14] A display control method executed by one or more computers, according to the present disclosure, includes: acquiring a deliverable time zone for an article to be delivered to a delivery destination by an unmanned vehicle capable of receiving radio waves from one or more positioning satellites and moving autonomously; acquiring satellite information relating to the one or more positioning satellites that can be captured at each of a plurality of positions between a delivery base of the article and the delivery destination in the deliverable time zone; and setting, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.
[15] A program according to the present disclosure, is configured to cause a computer to: acquire a deliverable time zone for an article to be delivered to a delivery destination by an unmanned vehicle capable of receiving radio waves from one or more positioning satellites and moving autonomously; acquire satellite information relating to the one or more positioning satellites that can be captured at each of a plurality of positions between a delivery base of the article and the delivery destination in the deliverable time zone; and set, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.

### REFERENCE SIGNS LIST

1 UAV
2 Delivery control server
11 Drive unit
12 Positioning unit
13 Communication unit
14 Sensor unit
15 Storage unit
16 Control unit
21 Communication unit
22 Storage unit
23 Control unit
231 Delivery procedure request receiving unit
232 Deliverable time zone acquisition unit
233 Presentation control unit
234 Candidate route identification unit
235 Satellite information acquisition unit
236 Delivery route setting unit
UT User terminal
S Delivery system
NW Communication network

What is claimed is:

1. A delivery route setting device comprising:
at least one memory configured to store program code; and at least one processor configured to access the program code and operate as instructed by the program code, the program code including:
first acquisition code configured to cause the at least one processor to acquire a deliverable time zone for an article to be delivered to a delivery destination by an unmanned vehicle capable of receiving radio waves from one or more positioning satellites and moving autonomously;
second acquisition code configured to cause the at least one processor to acquire satellite information relating to the one or more positioning satellites that can be captured at each of a plurality of positions between a delivery base of the article and the delivery destination in the deliverable time zone; and
setting code configured to cause the at least one processor to set, on the basis of the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.

2. A delivery route setting device according to claim 1, wherein the setting code is configured to cause the at least one processor to identify, on the basis of the satellite information, the position where positioning accuracy is less than or equal to the first threshold value in the deliverable time zone; and to set the delivery route that avoids the identified position.

3. A delivery route setting device according to claim 1, wherein the setting code is configured to cause the at least one processor to set, on the basis of the satellite information, the delivery route that passes through a position where the positioning accuracy is greater than or equal to a second threshold value in the deliverable time zone among the plurality of positions.

4. A delivery route setting device according to claim 3, wherein the satellite information includes a capture number of the one or more positioning satellites, the capture number being identified at each of the plurality of positions, and
the setting code is configured to cause the at least one processor to set the delivery route that passes through a position where the capture number is greater than or equal to a third threshold value.

5. A delivery route setting device according to claim 3, wherein the satellite information includes a reduction rate of the positioning accuracy, the reduction rate being identified at each of the plurality of positions, and
the setting code is configured to cause the at least one processor to set the delivery route that passes through a position where the reduction rate is less than or equal to a fourth threshold value.

6. A delivery route setting device according to claim 3, wherein the satellite information includes a capture number of the one or more positioning satellites and a reduction rate of the positioning accuracy, the capture number and the reduction rate being identified at each of the plurality of positions,
the setting code is configured to cause the at least one processor to set the delivery route that passes through a position where the capture number is greater than or equal to a third threshold value and the reduction rate is less than or equal to a fourth threshold value.

7. A delivery route setting device according to claim 3, wherein the setting code is configured to cause the at least one processor to set a first delivery route with priority over a second delivery route, the first delivery route being the delivery route that passes through the position where the positioning accuracy is greater than or equal to the second threshold value, and the second delivery route being a delivery route that passes through a position where a required travel time or a required travel distance from the delivery base to the delivery destination is equal to or less than a fifth threshold value.

8. A delivery route setting device according to claim 1, the program code further including identification code configured to cause the at least one processor to identify one or more candidate routes to be candidates for the delivery route; and
presentation control code configured to cause the at least one processor to present a plurality of different deliverable time zones in a selectable manner, to a delivery requester of the article;
wherein the second acquisition code is configured to cause the at least one processor to acquire the satellite information relating to the one or more positioning satellites that can be captured at each of a plurality of positions on the identified one or more candidate routes in each of the plurality of different deliverable time zones,
the setting code is configured to cause the at least one processor to determine, for each of the deliverable time zones, whether or not there is the candidate route whose the positioning accuracy satisfies a predetermined condition, on the basis of the satellite information acquired in each of the deliverable time zones,
the presentation control code is configured to cause the at least one processor to control the presentation of the deliverable time zones such that the delivery requester cannot select the deliverable time zone for which it is determined that there is not the candidate route whose the positioning accuracy satisfies the predetermined condition, and
the setting code is configured to cause the at least one processor to set the delivery route for the deliverable time zone selected by the delivery requester among the presented deliverable time zones.

9. A delivery route setting device according to claim 1, the program code further including identification code configured to cause the at least one processor to identify a plurality of candidate routes to be candidates for the delivery route;
wherein the second acquisition code is configured to cause the at least one processor to acquire, for each of the candidate routes, the satellite information relating to the one or more positioning satellites that can be captured at each of a plurality of positions on the identified one or more candidate routes in the deliverable time zone, and
the setting code is configured to cause the at least one processor to set, as the delivery route on the basis of the satellite information, the candidate route whose the positioning accuracy satisfies a predetermined condition in the deliverable time zone among the plurality of candidate routes.

10. A delivery route setting device according to claim 9, wherein in a case where there are a plurality of candidate routes whose the positioning accuracy satisfies the predetermined condition in the deliverable time zone, the setting code is configured to cause the at least one processor to set, as the delivery route, the candidate route that passes through a position with the highest positioning accuracy among the plurality of candidate routes.

11. A delivery route setting device according to claim 9, wherein in a case where there are a plurality of candidate routes whose the positioning accuracy satisfies the predetermined condition in the deliverable time zone, the setting code is configured to cause the at least one processor to set, as the delivery route, the candidate route that passes through more positions with the positioning accuracy higher than a reference value among the plurality of candidate routes.

12. A delivery route setting device according to claim 9, wherein the setting code is configured to cause the at least one processor to estimate, for each of the candidate routes, a delivery completion time to the delivery destination, and set the delivery route by excluding the candidate route whose the delivery completion time is not within the deliverable time zone among the plurality of candidate routes.

13. A delivery route setting device according to claim 1, the program code further including movement control code configured to cause the at least one processor to perform a movement control of the unmanned vehicle such that the unmanned vehicle autonomously moves the delivery route that avoids the position where positioning accuracy is less than or equal to the first threshold value in the deliverable time zone.

14. A display control method executed by one or more computers, comprising:
acquiring a deliverable time zone for an article to be delivered to a delivery destination by an unmanned vehicle capable of receiving radio waves from one or more positioning satellites and moving autonomously;
acquiring satellite information relating to the one or more positioning satellites that can be captured at each of a plurality of positions between a delivery base of the article and the delivery destination in the deliverable time zone; and
setting, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.

15. A non-transitory computer readable memory having stored thereon a program configured to cause a computer to:
acquire a deliverable time zone for an article to be delivered to a delivery destination by an unmanned vehicle capable of receiving radio waves from one or more positioning satellites and moving autonomously;
acquire satellite information relating to the one or more positioning satellites that can be captured at each of a plurality of positions between a delivery base of the article and the delivery destination in the deliverable time zone; and
set, based on the satellite information, a delivery route so as to avoid a position where positioning accuracy is less than or equal to a first threshold value in the deliverable time zone among the plurality of positions, the delivery route being a route for the unmanned vehicle to move autonomously from the delivery base to the delivery destination.
